(19) United States
(12) Patent Application Publication
(10) Pub. No.: US 2026/0006111 A1
(43) Pub. Date: Jan. 1, 2026

(54) System and Method for Recovering a Wireless Connection

(71) Applicant: ZEBRA TECHNOLOGIES CORPORATION, Lincolnshire, IL (US)

(72) Inventors: Anandakumar Gopalsamy, Ronkonkoma, NY (US); Ambika Nagarajaiah, Bangalore (IN); Dayal Rai, Bangalore (IN)

(21) Appl. No.: 18/759,130

(22) Filed: Jun. 28, 2024

(51) Int. Cl. H04L 69/40; H04L 41/0659

(52) U.S. Cl. CPC H04L 69/40; H04L 41/0661

(57) ABSTRACT

An example computing device includes: a communications interface; a memory storing: a primary connection profile including primary credentials for connecting to a primary network; a recovery connection profile including protected recovery credentials for connecting to a recovery network, wherein the protected recovery credentials are protected from modification by a user of the computing device; a processor interconnected with the communications interface and the memory, the processor configured to: control the communications interface to connect to the primary network using the primary credentials from the primary connection profile; in response to detecting a recovery condition, control the communications interface to connect to the recovery network using the recovery credentials from the recovery connection profile.

### BACKGROUND

Mobile devices may connect to wireless networks using credentials stored in connection profiles. Sometimes, the credentials may expire or may be incorrectly updated, resulting in the mobile device being unable to connect to a wireless network.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for recovering a wireless connection.

FIG. 2 is a block diagram of certain internal hardware components of certain devices of FIG. 1.

FIG. 3 is a flowchart of an example method of recovering a wireless connection

FIG. 4 is a flowchart of an example method of managing connection profiles.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a device comprising: a communications interface: a memory storing: a primary connection profile including primary credentials for connecting to a primary network: a recovery connection profile including protected recovery credentials for connecting to a recovery network, wherein the protected recovery credentials are protected from modification by a user of the computing device: a processor interconnected with the communications interface and the memory, the processor configured to: control the communications interface to connect to the primary network using the primary credentials from the primary connection profile: in response to detecting a recovery condition, control the communications interface to connect to the recovery network using the recovery credentials from the recovery connection profile.

Additional examples disclosed herein are directed to a method comprising: storing a primary connection profile including primary credentials for connecting to a primary network: storing a recovery connection profile including protected recovery credentials for connecting to a recovery network, wherein the protected recovery credentials are protected from modification by a user: connecting to the primary network using the primary credentials from the primary connection profile: in response to detecting a recovery condition, connecting to the recovery network using the recovery credentials from the recovery connection profile.

Additional examples disclosed herein are directed to a non-transitory machine-readable medium storing instructions which when executed, cause a computing device to: store a primary connection profile including primary credentials for connecting to a primary network: store a recovery connection profile including protected recovery credentials for connecting to a recovery network, wherein the protected recovery credentials are protected from modification by a user of the computing device: connect to the primary network using the primary credentials from the primary connection profile: in response to detecting a recovery condition, connect to the recovery network using the recovery credentials from the recovery connection profile.

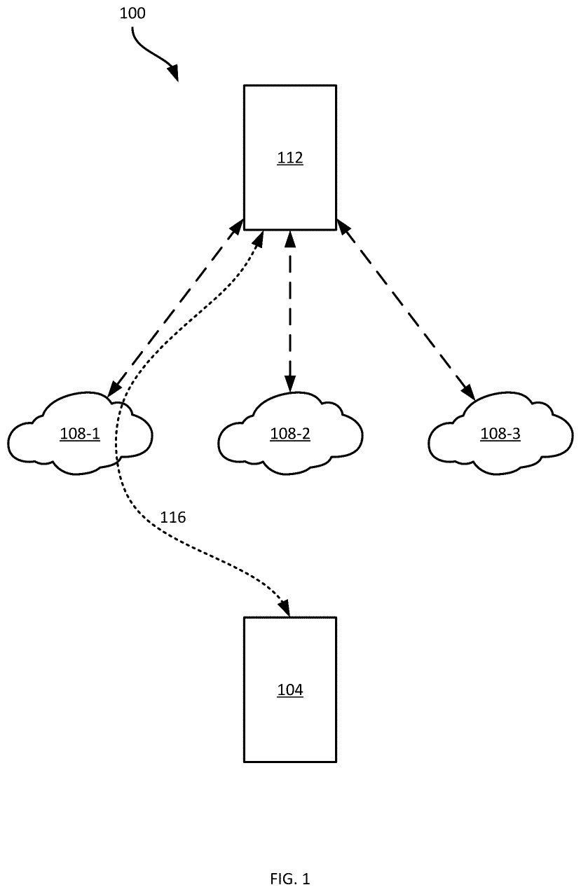

FIG. 1 depicts a system 100 for recovering a wireless connection in accordance with the teachings of this disclosure. The system 100 includes a computing device 104 (also referred to herein as simply the device 104) capable of connecting to wireless networks, of which three example wireless networks 108-1, 108-2, and 108-3 are depicted (referred to herein generically as a network 108 and collectively as the networks 108: this nomenclature is also used elsewhere herein). The device 104 may further be in communication with a server 112 via a link 116 which in the present example traverses the network 108-1. In other examples, the link 116 may traverse one of the other networks 108-2 or 108-3. In some examples, the link 116 may additionally traverse one or more wide-area networks such as the Internet, mobile networks, and the like.

The device 104 may be a mobile computing device such as a handheld computer, a mobile phone, a tablet, a barcode scanner or the like. As noted above, the device 104 is connected to the network 108, which may be deployed for wireless communications within a facility, such as a transportations and logistics facility, a warehouse, retail establishment, or other facility. Accordingly, the network 108 may be a wireless local area network (WLAN) and/or a wireless wide area network (WWAN) deployed by one or more base stations, including without limitation one or more access points and/or cellular base stations, citizens broadband radio service (CBRS) base stations, or the like.

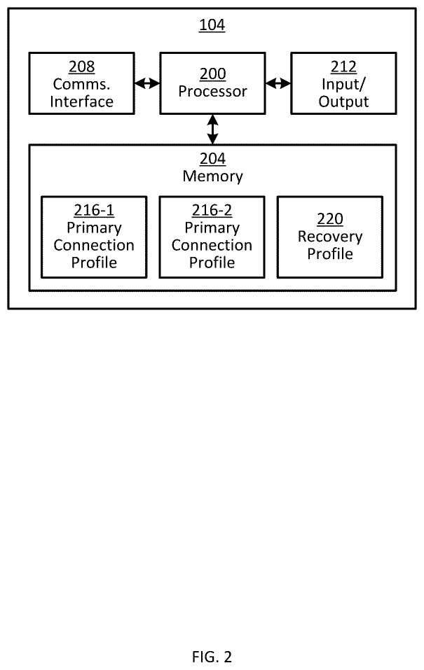

Turning now to FIG. 2, certain internal components of the computing device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes a communications interface 208 enabling the device 104 to exchange data with other computing devices, such as the server 112. The communications interface 208 is interconnected with the processor 200. The communications interface 208 may include a controller, and one or more antennas, transmitters, receivers, or the like (not shown), to allow the device 104 to communicate with other computing devices such as the server 112 over the network 108 via the link 116. The communications interface 208 may further allow the device 104 to communicate with (e.g., to broadcast signals, via a two-way communication link, etc.) other computing devices according to other communications protocols, such as a Bluetooth Low Energy protocol or other suitable wireless transmission protocol.

For example, the controller may be a micro-controller, a micro-processor, or other suitable device capable of executing computer-readable instructions to control the components, such as the antennae, transmitters, receivers, and the like, of the communications interface 208 to perform the functionality described herein. The controller may comprise one or more integrated circuits and may include and/or be interconnected with a non-transitory computer-readable storage medium storing computer-readable instructions which when executed configure the controller and/or the communications interface 208 to perform the functionality described herein. In particular, the controller may control a wireless connection operation of the device 104.

The device 104 may further include one or more input and/or output devices 212 suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

The memory 204 is further configured to store a set of primary connection profiles 216. Each of the primary connection profiles 216 includes a network identifier and configurable primary credentials for connecting to one of the wireless networks 108, as identified by the network identifier. For example, the primary connection profile 216-1 may include primary credentials for connecting to the wireless network 108-1, while the primary connection profile 216-2 may include primary credentials for connecting to the wireless network 108-2. Accordingly, the wireless networks 108-1 and 108-2 may be referred to as primary networks 108-1 and 108-2. The primary credentials may include usernames and/or passwords, authentication tokens, or other suitable credentials to authenticate access to the given network 108.

In other examples, the device 104 may store more or fewer primary connection profiles 216. Further, the device 104 may store more than one primary connection profile 216 to connect to the same given network 108, for example, with each primary connection profile 216 defining different credentials (e.g., for different authentication methods or the like) for connecting to the given network 108.

The primary connection profiles 216 may further be configurable, for example, by a user of the device 104, via interaction with the input device 212. For example, the primary connection profiles 216 may be displayed at a user interface for wireless connections (i.e., for connecting to the wireless networks 108). The primary connection profiles 216 may therefore be manually selectable, for example to initiate a connection to a nearby network 108. The primary credentials of the primary connection profiles 216 may further be configurable, for example to save a new password or otherwise new authentication details for connecting to the corresponding network 108.

Additionally or alternatively, the primary connection profiles 216 may be configurable by the server 112, for example via communication over the link 116. That is, an enterprise managed device 104 may receive updates from the server 112 for the primary connection profiles 216 to similarly update the primary credentials to save new passwords or other new authentication details for connecting to the corresponding network 108.

The memory 204 is further configured to store a recovery profile 220 including protected recovery credentials for connecting to one of the wireless networks 108. For example, the recovery profile 220 may include recovery credentials for connecting to the wireless network 108-3, and accordingly, the wireless network 108-3 may also be referred to as a recovery network 108-3. In other examples, the recovery network 108 may be the same as one of the primary networks 108, with the recovery profile 220 defining different credentials to connect to the primary network 108. In further examples, the device 104 may store more than one recovery profile 220.

In particular, the recovery profile 220 may have a protected status to protect the recovery credentials from being intentionally or inadvertently modified. For example, the recovery profile 220 may be marked or flagged as having the protected status in the memory 204. As a result of the protected status, the recovery profile 220 may be hidden or blocked from configuration, interaction and display at the user interface for connecting to the wireless networks 108. Additionally, in some examples, the recovery profile 220 may be protected from configuration and/or revision by remote devices, such as the server 112, to similarly prevent inadvertent mistakes in modification. In such examples, the device 104 may simply store multiple recovery profiles 220 with the updated information, rather than modifying an existing stored recovery profile 220. In other examples, the recovery profile 220 may be modified by the server 112 provided a specific authentication method, such as via an enterprise-managed mobile device management system, or the like.

The system 100 may be deployed to allow recovery of wireless connections by individual devices which may facilitate locating misplaced devices, for example in a large facility, or correcting erroneous updates to the primary connection profiles, or similar. In particular, the recovery profiles 220 are protected from configuration by users at the devices 104 themselves, and may only be modified by the server 112 via specific authentication, thereby protecting at least the recovery profiles 220 against inadvertent and erroneous updates, and providing a backup option for recovering a wireless connection.

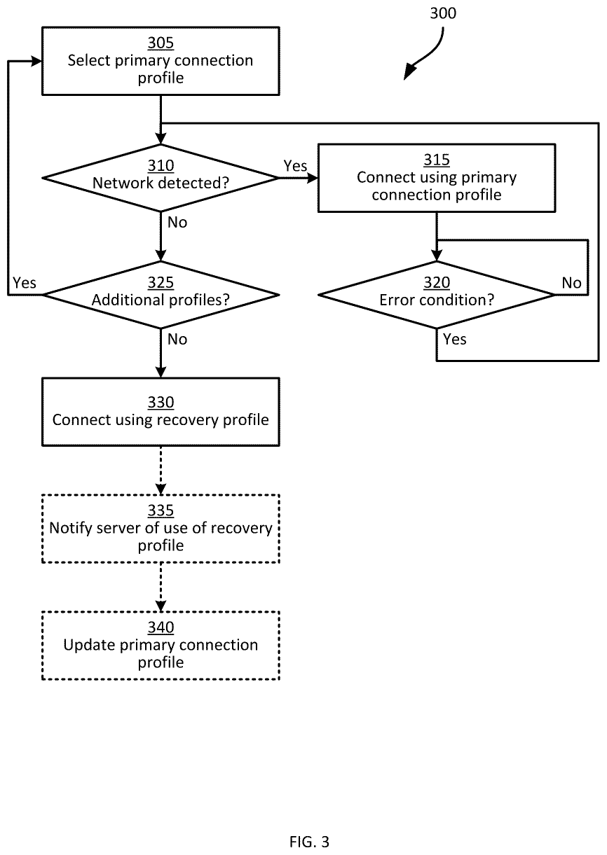

Turning now to FIG. 3, the functionality implemented by the device 104 will be discussed in greater detail. FIG. 3 illustrates a method 300 of recovering a wireless connection. The method 300 will be discussed in conjunction with its performance in the system 100, and particularly by the device 104. In particular, the method 300 will be described with reference to the components of FIGS. 1 and 2. In other examples, the method 300 may be performed by other suitable devices or systems.

The method 300 is initiated at block 305, where the device 104 is configured to select one of the primary connection profiles 216 stored in the memory 204. If more than one primary connection profile 216 exists, then the device 104 may select one of the primary connection profiles 216, for example based on a predefined priority order, a default selection, a user selection, or the like. In other examples, the device 104 may select the primary connection profile 216 according to a signal strength to a nearest access point or base station of the corresponding wireless network 108 or the like.

At block 310, the device 104 is configured to check for the wireless network 108 corresponding to the primary connection profile 216 selected at block 305. In particular, the primary connection profile 216 may specify a network identifier, and accordingly the device 104 may search for the network 108 corresponding to the network identifier.

If the determination at block 310 is affirmative, that is, the device 104 detects the corresponding network 108 identified in the primary connection profile 216 selected at block 305, then the device 104 proceeds to block 315. At block 315, the device 104 may initiate a connection to the network 108 using the primary credentials stored in the primary connection profile 216.

At block 320, the device 104 monitors for an error condition in the connection to the network 108. The error condition may be an error in the initial connection operation, for example due to invalid primary credentials, timeout issues, or the like. In other examples, the error condition may be a disconnection from the network 108 or another error subsequent to a successful initial connection. The device 104 may continue to monitor for an error condition in the connection to the network 108.

If an error condition is detected at block 320, the device 104 may be configured to return to block 305 to select another primary connection profile 216. For example, in response to a disconnection from a network 108, the device 104 may prioritize selection of a primary connection profile 216 having a network identifier matching the previously connected network 108. That is, the device 104 may first determine whether any other primary connection profiles 216 are available for the network 108. For example, the primary credentials associated with the primary connection profile 216 initially selected may be expired, and hence the device 104 may select a different primary connection profile 216 for the same network 108 to initialize a connection with different primary credentials. The device 104 may then proceed to confirm whether the network 108 is still detected and if so, to attempt a connection using the primary credentials of the newly selected primary connection profile 216.

If the determination at block 310 is negative, that is, the device 104 does not detect the network 108 corresponding to the primary connection profile 216 selected at block 305, then the device 104 may proceed to block 325. At block 325, the device 104 may determine whether any additional primary connection profiles 216 are available for selection for which a connection attempt has not already been made.

If the determination at block 325 is affirmative, then the device 104 returns to block 305 to select one of the other primary connection profiles 216 to initiate a connection attempt with the corresponding network 108. For example, if the device 104 is mobile and moves out of range of a first network 108, then the device 104 may subsequently select a different primary connection profile 216 configured for connection to a second network 108. Alternately, the device 104 may iterate through blocks 305 through 325 until a primary connection profile 216 is selected for which the corresponding network 108 is within range of the device 104.

If the determination at block 325 is negative, that is, there are no further primary connection profiles detected by the device 104, then the device 104 proceeds to block 330. At block 330, the device 104 may retrieve the recovery profile 220 and initiates a connection attempt to the recovery network 108 identified by the network identifier using the recovery credentials stored in the recovery profile 220. That is, the device 104 may identify a recovery condition for which the recovery profile 220 should be utilized when there are no further primary connection profiles 216 which may be used to connect to a detected network 108.

In examples where multiple recovery profiles 220 exist, the device 104 may select one of the recovery profiles 220, for example according to a predefined priority order and/or default selection of the recovery profiles 220.

If the recovery network 108 for the recovery profile 220 is not available or if there is an error in the connection (e.g., the recovery credentials are invalid), then the device 104 may iterate through any stored recovery profiles 220 to initiate a connection attempt to the corresponding recovery networks 108. If the device 104 is unable to connect using any of the recovery profiles 220, then the device 104 may identify an error condition and the method 300 may end. In some examples, the device 104 may issue a notification, such as an audio or visual alert to notify nearby operators of the connection issues.

In some examples, upon a successful connection via the recovery network 108, the device 104 may proceed to block 335 to alert the server 112 of the use of the recovery profile 220 to connect to one of the networks 108. In particular, the alert may serve as an indication that one or more of the primary connection profiles 216 are to be updated with new credentials. Accordingly, in some examples, the alert include an indication of one or more of the primary connection profiles 216, an indication of the network identifiers to identify the networks 108 for which connections were unsuccessful or the like.

In response to the alert, the server 112 may retrieve or generate one or more updated primary connection profiles 216, for example including updated primary credentials. The server 112 may further send the updated primary connection profiles 216 to the device 104. Upon receipt of updated primary connection profiles 216, the device 104 may, at block 340, update the primary connection profiles 216 stored in the memory 204.

In other examples, the alert may serve as an indication that the device 104 may have been lost or misplaced, for example in the facility in which the system 100 is deployed. Accordingly, the server 112 may initiate a locationing functionality (e.g., to trigger the device 104 to emit beacons or audio signals or to detect signal strengths to nearby access points or the like) to facilitate locating the device 104 by an operator.

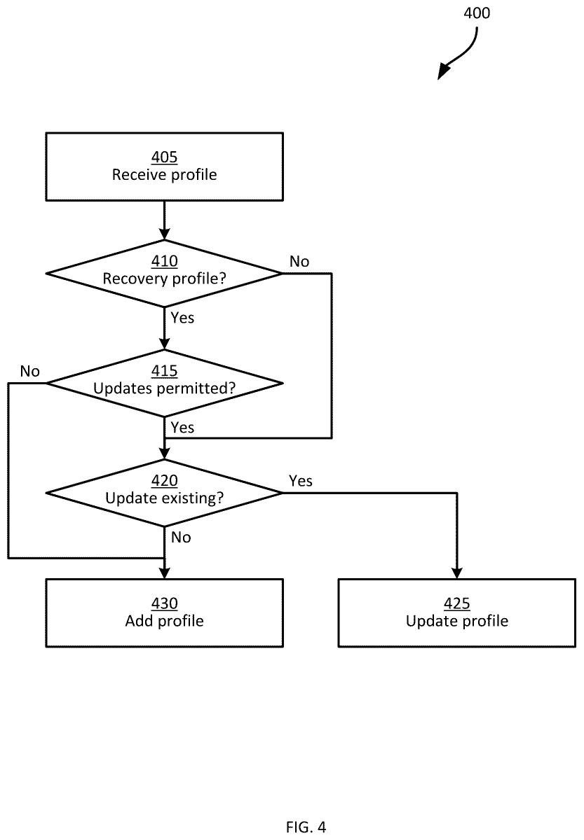

Referring to FIG. 4, a flowchart of an example method 400 of managing profiles at the device 104 is depicted.

At block 405, the device 104 receives a connection profile, for example from the server 112. The connection profile may be a recovery profile 220 or a primary connection profile 216, and in particular, may be marked or flagged according to its type. In some examples, in response to receiving the profile, the device 104 may check the validity of the update, for example to review the form of the profile and the update request. If the update is invalid (e.g., is malformed), then the device 104 may return an error, for example as an audio or visual notification at the output devices 212 of the device 104, or as a message to the server 112 or the like.

At block 410, the device 104 determines whether the profile received at block 405 is a recovery profile 220. If the determination at block 410 is affirmative, then the device 104 proceeds to block 415.

At block 415, the device 104 may determine whether updates to the recovery profiles 220 are permitted. In particular, since the recovery profiles 220 are marked with a protected status in the memory 204, the device 104 may, in some examples, not accept any updates at all, or in other examples, only accept updates from authenticated sources. For example, the device 104 may only accept update instructions from an authenticated source, such as via a mobile device management application or the like. In some examples, the protected status specified in memory may additionally identify update permissions for individual recovery profiles 220. The additional authentication of the update source and comparison against update permissions based on the protected status of the recovery profiles 220 may reduce the likelihood that a recover profile 220 is incorrectly or inadvertently updated.

If the determination at block 415 is affirmative, that is, updates to the recovery profile 220 are permitted, or if the determination at block 410 is negative, that is, the profile received at block 405 is a primary connection profile, then the device 104 proceeds to block 420. At block 420, the device 104 determines whether the profile received at block 405 indicates an update to an existing profile. In some examples, the connection profile received at block 405 may be accompanied by an explicit update instruction, including, for example, an identifier of the primary connection profile 216 or recovery profile 220 to be updated. In other examples, the device 104 may infer that an existing connection profile is to be updated, based on matching parameters of the connection profile. For example, if the network identifier for the network 108 and the type of authentication of the incoming connection profile matches those of an existing connection profile, then the device 104 may determine that the existing connection profile is to be updated.

If the determination at block 420 is affirmative, then the device 104 proceeds to block 425 to update the primary connection profile 216 or the recovery profile 220.

If the determination at block 420 is negative, that is, the device 104 determines that the no existing connection profiles are to be updated, or if the determination at block 415 is negative, that is, updates to recovery profiles (or the specific recovery profile 220, as applicable) are permitted, then the device 104 proceeds to block 430. At block 430, the device 104 adds the new connection profile received at block 204 to the memory. For example, if the new connection profile is a primary connection profile, then the device 104 may add a new primary connection profile 216 to be stored in the memory 204 and make the new primary connection profile 216 available for user-configurability, for example in the user interface for wireless connections. Similarly, if the new connection profile is a recovery profile, then the device 104 may add the new recovery profile 220 to be stored in the memory 204, mark the new recovery profile 220 with a protected status, and restrict the new recovery profile 220 from visibility or availability from user configuration in the user interface for wireless connections.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising.” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device comprising:
a communications interface;
a memory storing:
a primary connection profile including primary credentials for connecting to a primary network;
a recovery connection profile including protected recovery credentials for connecting to a recovery network, wherein the protected recovery credentials are protected from modification by a user of the computing device;
a processor interconnected with the communications interface and the memory, the processor configured to:
control the communications interface to connect to the primary network using the primary credentials from the primary connection profile; and
in response to detecting a recovery condition, control the communications interface to connect to the recovery network using the protected recovery credentials from the recovery connection profile.

2. The computing device of claim 1, wherein the processor is configured to control the communications interface to connect to the primary network in response to detecting the primary network.

3. The computing device of claim 1, wherein the recovery condition comprises one of:
a disconnection from the primary network; and
an error condition in connecting to the primary network.

4. The computing device of claim 1, wherein the memory stores a set of further primary connection profiles, each further primary connection profile including respective further primary credentials for connecting to a respective further primary network.

5. The computing device of claim 4, wherein the recovery condition comprises an error condition in connecting to one of the primary network and the further primary network.

6. The computing device of claim 1, wherein the processor is further configured to:
alert a server of use of the recovery connection profile; and
receive an updated primary connection profile from the server, the updated primary connection profile having updated primary credentials for connecting to the primary network.

7. The computing device of claim 1, wherein the processor is further configured to:
receive, from a server, an updated recovery connection profile:
determine whether updates by the server are permitted for the recovery connection profile:
when updates by the server are permitted, update the recovery connection profile according to the updated recovery connection profile: and
when updates by the server are not permitted, store, in the memory, a new recovery connection profile according to the updated recovery connection profile.

8. The computing device of claim 1, wherein the processor is further configured to:
display, at a user interface, the primary connection profile for selection and modification: and
hide the recovery connection profile from selection at the user interface to prevent modification.

9. A method comprising:
storing a primary connection profile including primary credentials for connecting to a primary network:
storing a recovery connection profile including protected recovery credentials for connecting to a recovery network, wherein the protected recovery credentials are protected from modification by a user:
connecting to the primary network using the primary credentials from the primary connection profile; and
in response to detecting a recovery condition, connecting to the recovery network using the protected recovery credentials from the recovery connection profile.

10. The method of claim 9, comprising connecting to the primary network in response to detecting the primary network.

11. The method of claim 9, wherein the recovery condition comprises one of:
a disconnection from the primary network; and
an error condition in connecting to the primary network.

12. The method of claim 9, further comprising storing a set of further primary connection profiles, each further primary connection profile including respective further primary credentials for connecting to a respective further primary network.

13. The method of claim 12, wherein the recovery condition comprises an error condition in connecting to one of the primary network and the further primary networks.

14. The method of claim 9, further comprising:
alerting a server of use of the recovery connection profile; and
receiving an updated primary connection profile from the server, the updated primary connection profile having updated primary credentials for connecting to the primary network.

15. The method of claim 9, further comprising:
receiving an updated recovery connection profile;
determining whether updates by the server are permitted for the recovery connection profile;
when updates by the server are permitted, updating the recovery connection profile according to the updated recovery connection profile: and
when updates by the server are not permitted, storing a new recovery connection profile according to the updated recovery connection profile.

16. The method of claim 9, further comprising:
displaying, at a user interface, the primary connection profile for selection and modification; and
hiding the recovery connection profile from selection at the user interface to prevent modification

17. A non-transitory machine-readable medium storing instructions which when executed, cause a computing device to:
store a primary connection profile including primary credentials for connecting to a primary network:
store a recovery connection profile including protected recovery credentials for connecting to a recovery network, wherein the protected recovery credentials are protected from modification by a user of the computing device;
connect to the primary network using the primary credentials from the primary connection profile; and
in response to detecting a recovery condition, connect to the recovery network using the protected recovery credentials from the recovery connection profile.

18. The non-transitory machine-readable medium of claim 17, wherein the recovery condition comprises one of:
a disconnection from the primary network; and
an error condition in connecting to the primary network.

19. The non-transitory machine-readable medium of claim 17, the instructions further configuring the computing device to:
alert a server of use of the recovery profile; and
receive an updated primary connection profile from the server, the updated primary connection profile having updated primary credentials for connecting to the primary network.

20. The non-transitory machine-readable medium of claim 17, the instructions further configuring the computing device to:
in response to receiving an updated recovery connection profile, determine whether updates by a server are permitted for the recovery profile;
when updates by the server are permitted, update the recovery connection profile according to the updated recovery connection profile; and
when updates by the server are not permitted, store a new recovery connection profile according to the updated recovery connection profile.
